(19) United States
(12) Patent Application Publication
(10) Pub. No.: US 2025/0334965 A1
(43) Pub. Date: Oct. 30, 2025

(54) APPARATUS FOR CONTROLLING ROBOT AND METHOD THEREOF

(71) Applicants: Hyundai Motor Company, Seoul (KR); Kia Corporation, Seoul (KR)

(72) Inventor: Se Hwan Kim, Suwon-si (KR)

(21) Appl. No.: 18/911,521

(22) Filed: Oct. 10, 2024

(30) Foreign Application Priority Data
Apr. 24, 2024 (KR) 10-2024-0054895

(51) Int. Cl. G05D 1/229; G05D 101/00; G05D 111/30

(52) U.S. Cl. CPC G05D 1/2297; G05D 2101/22; G05D 2111/32

(57) ABSTRACT

An apparatus for controlling a robot is introduced. The apparatus may comprise at least one memory storing at least one instruction, a communication device for communication with at least one server, and at least one processor operatively coupled to the memory. The instruction, when executed by the processor, may enable the apparatus to store a first configuration file received from a first server, where the first file contains information about a first user's robot settings and determine a second configuration file from a second server, different from the first, comprise information about a second user's settings. Based on both configuration files, the apparatus determines a target file containing information about a target setting for controlling the robot. The robot is controlled based on the target information.

### CROSS-REFERENCE TO RELATED APPLICATION

This application claims the benefit of priority to Korean Patent Application No. 10-2024-0054895, filed in the Korean Intellectual Property Office on Apr. 24, 2024, the entire contents of which are incorporated herein by reference.

### TECHNICAL FIELD

The present disclosure relates to a robot control apparatus and a control method thereof, and more particularly, relates to a technology for supporting a user setting function of a service robot.

### BACKGROUND

The matters described in this Background section are only for enhancement of understanding of the background of the disclosure, and should not be taken as acknowledgement that they correspond to prior art already known to those skilled in the art.

When a robot user sets a robot, it may be provided to set the robot by setting the robot through a robot operation control or to set the robot through a robot client. In particular, the robot setting provided initially may not be changed.

As a robot service is operated, the robot setting function, which was set through the client software of each robot, may be set by the robot operation control, or the robot setting function, which was set by the robot operation control, may be provided as a robot setting function in the client software of each robot. As robot operation services become more sophisticated, frequent changes are used in the robot setting.

To address these challenges, there is a need to develop a technology for increasing the user's convenience in operating a robot, by changing a robot setting function, which is provided by a provider such that the user is capable of setting the robot, in a setting method of a robot client, a setting method of the robot operation control, and a method using a value set by the robot software provider.

### SUMMARY

According to the present disclosure, an apparatus for controlling a robot, the apparatus may comprise at least one memory storing at least one instruction, a communication device configured to support communication with at least one server, and at least one processor operatively coupled to the at least one memory, wherein the at least one instruction, when executed by the at least one processor, is configured to cause the apparatus to store, based on determining that a first configuration file is received via the communication device from a first server, the first configuration file, wherein the first configuration file may comprise first information about a first user's setting of the robot, determine a second configuration file received via the communication device from a second server different from the first server, wherein the second configuration file may comprise second information about a second user's setting of the robot, and wherein the second user is different from the first user, determine, based on the first configuration file and the second configuration file, a target file, wherein the target file may comprise target information about a target setting associated with control of the robot, and control, based on the target information, the robot.

The apparatus, wherein the at least one instruction, when executed by the least one processor, is configured to cause the apparatus to determine, based on the first configuration file or the second configuration file, first setting information and second setting information, wherein each of the first setting information and the second setting information may comprise at least one of a parameter name associated with a setting or a value related to the setting, and determine first selection information of the first setting information and second selection information of the second setting information, wherein each of the first selection information and the second selection information may comprise information about permission of the setting.

The apparatus, wherein the at least one instruction, when executed by the at least one processor, is configured to cause the apparatus to apply, based on the first selection information being decided by the first user, the first setting information to the target file, wherein the first setting information is included in the first configuration file, and apply, based on the second selection information being decided by the second user, the second setting information to the target file, wherein the second setting information is included in the second configuration file.

The apparatus, wherein the at least one instruction, when executed by the at least one processor, is configured to cause the apparatus to apply, based on the first selection information being decided by the second user, the first setting information to the target file, wherein the first setting information is included in the second configuration file, and apply, based on the second selection information being decided by the first user, the second setting information to the target file wherein the second setting information is included in the first configuration file.

The apparatus, wherein the at least one instruction, when executed by the at least one processor, is configured to cause the apparatus to, based on the first selection information of the first setting information being the same as the second selection information of the second setting information, apply at least one of the first setting information or the second setting information to the target file by comparing a first priority of the first setting information with a second priority of the second setting information, wherein the first selection information of the first setting information may comprise information about permission, wherein the first setting information is decided by at least one of the first user or the second user, and wherein the second selection information of the second setting information may comprise information about permission, where the second setting information is decided by at least one of the first user or the second user.

The apparatus, wherein the at least one instruction, when executed by the at least one processor, is configured to cause the apparatus to determine, based on the second selection information being decided by the second user, the second setting information from the second configuration file, based on the second setting information not being determined from the second configuration file, transmit, to the second server, information for requesting a decision of the second user about the second setting information, and apply, based on receiving the second configuration file decided by the second user from the second server, the second setting information to the target file, wherein the second setting information is included in the second configuration file.

The apparatus, wherein the at least one instruction, when executed by the at least one processor, is configured to cause the apparatus to determine, based on the first user deciding the first information about the first user's setting of the robot through the first server, the first configuration file from the first server, wherein the first user is a robot software provider, and determine, based on the second user deciding the second information about the second user's setting of the robot through the second server, the second configuration file from the second server, wherein the second server is configured to provide a robot operation control.

The apparatus, wherein the at least one instruction, when executed by the at least one processor, is configured to cause the apparatus to store, based on identifying a notification regarding a change in the first configuration file from the first server, the first configuration file, which is changed, in the at least one memory.

The apparatus, wherein the at least one instruction, when executed by the at least one processor, is configured to cause the apparatus to determine a third configuration file pre-stored before the first configuration file is stored in the at least one memory, determine the target information about the target setting of the robot from the third configuration file, and determine whether the target information is included in the first configuration file.

The apparatus, wherein the at least one instruction, when executed by the at least one processor, is configured to cause the apparatus to determine, based on the target information being included in the first configuration file, the target file by determining the first information about the first user's setting of the robot from the first configuration file, and determine, based on the target information not being included in the first configuration file, the target file through the third configuration file.

According to the present disclosure, a method performed by an apparatus for controlling a robot, the method may comprise storing, based on determining that a first configuration file is received from a first server, the first configuration file in at least one memory, wherein the first configuration file may comprise first information about a first user's setting of a robot, determining a second configuration file received from a second server different from the first server, wherein the second configuration file may comprise second information about a second user's setting of the robot, and wherein the second user is different from the first user, determining, based on the first configuration file and the second configuration file, a target file, wherein the target file may comprise target information about a target setting associated with control of the robot, and controlling, based on the target information, the robot.

The method, wherein the controlling the robot may comprise determining, based on the first configuration file or the second configuration file, first setting information and second setting information, wherein each of the first setting information and the second setting information may comprise at least one of a parameter name associated with a setting or a value related to the setting, and determining first selection information of the first setting information and second selection information of the second setting information, wherein each of the first selection information and the second selection information may comprise information about permission of the setting.

The method, wherein the controlling the robot may comprise applying, based on the first selection information being decided by the first user, the first setting information to the target file, wherein the first setting information is included in the first configuration file, and applying, based on the second selection information being decided by the second user, the second setting information to the target file, wherein the second setting information is included in the second configuration file.

The method, wherein the controlling the robot may comprise applying, based on the first selection information being decided by the second user, the first setting information to the target file, wherein the first setting information is included in the second configuration file, and applying, based on the second selection information being decided by the first user, the second setting information to the target file wherein the second setting information is included in the first configuration file.

The method, wherein the controlling the robot may comprise based on the first selection information of the first setting information being the same as the second selection information of the second setting information, applying at least one of the first setting information or the second setting information to the target file by comparing a first priority of the first setting information with a second priority of the second setting information, wherein the first selection information of the first setting information may comprise information about permission, wherein the first setting information is decided by at least one of the first user or the second user, and wherein the second selection information of the second setting information may comprise information about permission, where the second setting information is decided by at least one of the first user or the second user.

The method, wherein the controlling the robot may comprise determining, based on the second selection information being decided by the second user, the second setting information from the second configuration file, based on the second setting information not being determined from the second configuration file, transmitting, to the second server, information for requesting a decision of the second user about the second setting information, and applying, based on receiving the second configuration file decided by the second user from the second server, the second setting information to the target file, wherein the second setting information is included in the second configuration file.

The method, wherein the controlling the robot may comprise determining, based on the first user deciding the first information about the first user's setting of the robot through the first server, the first configuration file from the first server, wherein the first user is a robot software provider, and determining, based on the second user deciding the second information about the second user's setting of the robot through the second server, the second configuration file from the second server, wherein the second server is configured to provide a robot operation control.

The method, wherein the controlling the robot may comprise storing, based on identifying a notification regarding a change in the first configuration file from the first server, the first configuration file, which is changed, in the at least one memory.

The method, wherein the controlling the robot may comprise determining a third configuration file pre-stored before the first configuration file is stored in the at least one memory, determining the target information about the target setting of the robot from the third configuration file, and determining whether the target information is included in the first configuration file.

The method, wherein the controlling the robot may comprise determining, based on the target information being included in the first configuration file, the target file by determining the first information about the first user's setting of the robot from the first configuration file, and determining, based on the target information not being included in the first configuration file, the target file through the third configuration file.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a robot control apparatus, according to an example of the present disclosure;

FIG. 2 shows an example of a method for controlling a robot, according to an example of the present disclosure;

FIG. 3 shows an example of a method of storing a first configuration file in a robot control apparatus, according to an example of the present disclosure;

FIG. 4 shows an example of a method of controlling a robot (e.g., service robots such as guide robots, delivery robots, or disinfection robots, etc.) through a target file based on a first configuration file and a second configuration file in a robot control apparatus, according to an example of the present disclosure;

FIG. 5 shows an example of a method of controlling a robot through a target file based on first to third configuration files in a robot control apparatus, according to an example of the present disclosure;

FIG. 6 shows an example of a first configuration file, a second configuration file, a third configuration file, and a target file in a robot control apparatus, according to an example of the present disclosure;

FIG. 7 shows an example of subjects that determine a configuration file related to control of a robot in a robot control apparatus, according to an example of the present disclosure; and

FIG. 8 shows an example of a computing system related to a robot control apparatus or a robot control method, according to an example of the present disclosure.

With regard to description of drawings, the same or similar components will be marked by the same or similar reference signs.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted when they may make subject matters of the present disclosure unnecessarily obscure. Hereinafter, various examples of the present disclosure may be described with reference to accompanying drawings. Accordingly, those of ordinary skill in the art will recognize that modification, equivalent, and/or alternative on the various examples described herein may be variously made without departing from the scope and spirit of the present disclosure. With regard to description of drawings, similar components may be marked by similar reference numerals.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein. For example, the terms, such as “first”, “second”, and the like used herein may refer to various elements of various examples of the present disclosure, but do not limit the elements. For example, “a first user device” and “a second user device” may indicate different user devices regardless of the order or priority thereof. For example, without departing the scope of the present disclosure, a first complement may be referred to as a second component, and similarly, a second complement may be referred to as a first complement.

In this specification, the expressions “possess”, “may possess”, “include” and

“comprise”, or “may include” and “may comprise” used herein indicate existence of corresponding features (e.g., elements such as numeric values, functions, operations, or components) but do not exclude presence of additional features.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there is no intervening element (e.g., a third element).

According to the situation, the expression “configured to” used herein may be used as, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device. The terms used in the specification are only used to describe a specific example and are not intended to limit the scope of the present disclosure. The terms of a singular form may include plural forms unless otherwise specified. All the terms used herein, which include technical or scientific terms, may include the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various examples of the present disclosure. In some cases, even though terms are terms which are defined in the specification, they may not be interpreted to exclude examples of the present disclosure.

In the present disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Moreover, in describing a component of an example of the present disclosure, the expressions at least one of “A or B”, “at least one of A and B”, “at least one of A or B”, “A, B, or C”, “at least one of A, B, and C”, or “at least one of A, B, or C, or any combination thereof” may include any and all combinations of one or more of the associated listed items. In particular, expressions “at least one of A, B, or C, or any combination thereof” may include A, B, or C, or any combination thereof such as AB, ABC, or the like.

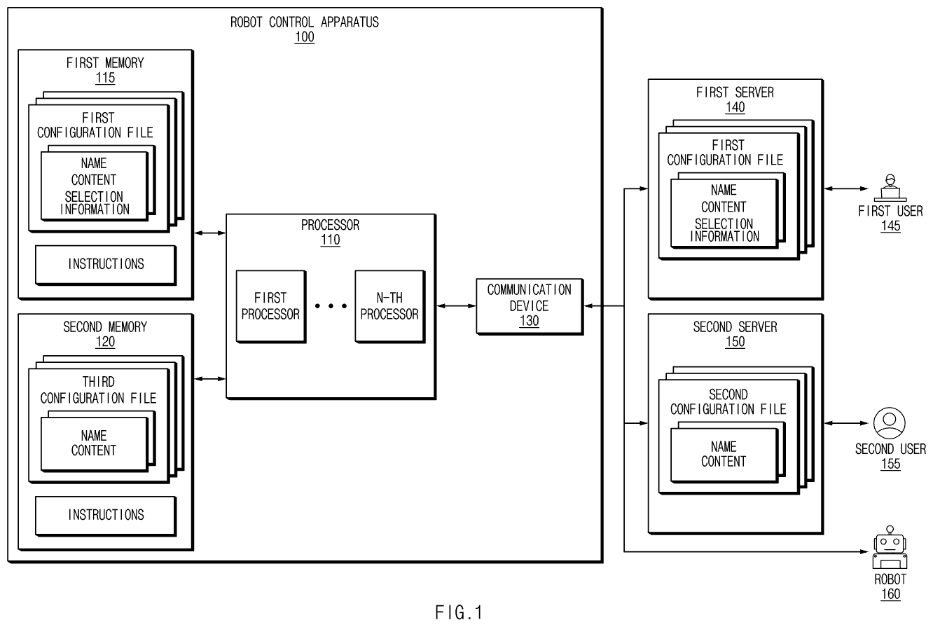

Hereinafter, examples of the present disclosure will be described in detail with reference to FIGS. 1 to 8.

FIG. 1 shows an example of a robot control apparatus, according to an example of the present disclosure.

A robot control apparatus 100 according to an example may include a processor 110, a first memory 115 including a first configuration file and instructions, a second memory 120 including a third configuration file and instructions, and a communication device 130.

The robot control apparatus 100 may indicate an apparatus that controls a robot 160 (e.g., service robots such as guide robots, delivery robots, or disinfection robots, etc.) by applying information about settings of the robot 160 included in a target file to the robot 160. For example, the robot control apparatus 100 may store the first configuration file stored in the first server 140 to the first memory 115. The robot control apparatus 100 may identify a setting name stored in the third configuration file by identifying the third configuration file stored in the second memory 120. The robot control apparatus 100 may determine whether the setting name stored in the third configuration file is included in the first configuration file stored in the first memory 115. If the first configuration file includes the setting name stored in the third configuration file, the robot control apparatus 100 may determine a target file used to control the robot 160 by identifying selection information included in the first configuration file. For example, a configuration file (e.g., a first configuration file) may include a setting name, setting content, and selection information of the setting. The robot control apparatus 100 may determine the configuration file to be applied to the target file by identifying selection information of the setting. When the target file is determined, the robot control apparatus 100 may control the robot 160 by applying the target file to the robot 160.

The processor 110 may include at least one processor. For example, the processor may execute software and may control at least one other component (e.g., a hardware or software component) connected to the processor. Besides, the processor may also perform various data processing or operations. For example, the processor may store configuration files and instructions in a memory (e.g., the first memory 115 and the second memory 120).

For reference, the processor may perform all operations performed by the robot control apparatus 100. Therefore, for convenience of description in this specification, an operation performed by the robot control apparatus 100 is mainly described as an operation performed by the processor. Furthermore, for convenience of description in this specification, the processor is mainly described as a single processor, but is not limited thereto. For example, the robot control apparatus 100 may include at least one processor. The at least one processor may perform all operations related to robot control operations.

The memory may include the first memory 115 and the second memory 120. The memory (e.g., a random-access memory (RAM), an embedded multi-media card (eMMC), a data scratch pad RAM (DSPR), a data local memory unit (DLMU), a local memory unit (LMU), or a default application memory (DAM), etc.) may temporarily and/or permanently store various pieces of data and/or information used to perform robot control.

The communication device 130 may support communication between the robot control apparatus 100 and the first server 140, the second server 150, or the robot 160. For example, the communication device 130 may include one or more components for communicating between the robot control apparatus 100 and the first server 140, the second server 150, or the robot 160. For example, the communication device 130 may include a short-range wireless communication device, a microphone, or the like. In this case, short-range communication technologies include wireless LAN (Wi-Fi), Bluetooth, ZigBee, Wi-Fi Direct (WFD), ultra-wideband (UWB), infrared data association (IrDA), Bluetooth Low Energy (BLE), and near field communication (NFC), and the like, but are not limited thereto.

The first server 140 may store the first configuration file decided by a first user 145. For example, the first server 140 may indicate a server that distributes the first configuration file. If a new function is added or a function is changed by the first user 145, which is a robot software provider, the first server 140 may change the first configuration file and may store the first configuration file. Here, the first configuration file may refer to a file that stores setting values related to functions capable of being set by the first user 145, and may include a setting name, setting content, and selection information of the setting according to the robot's function (e.g., guiding, delivering, cleaning, or disinfecting, etc.). The first server 140 may store at least one first configuration file, depending on a function.

A second server 150 may store the second configuration file decided by a second user 155. For example, the second server 150 may indicate a server that provides a robot operation control. The second server 150 may be provided by the first user 145, which is a robot software provider. If new functions are added or functions are changed by the second user 155 who uses the robot 160, the second server 150 may change a second configuration file and may store the second configuration file. Here, the second configuration file may refer to a file that stores setting values related to functions capable of being set by the second user 155 (e.g., setting the robot's volume, warning trigger conditions, or movement speed depending on the environment or purpose of a store where the robot is installed, etc.), and may include a setting name, setting content, and selection information of the setting according to the robot's function. The second server 150 may store at least one second configuration file, depending on a function.

For reference, in this specification, for convenience of description, the first configuration file and the second configuration file may be described as including information about the settings of the same robot. For example, information about the robot's settings may include at least one piece of setting information. For example, information about the robot's settings may include first setting information and second setting information.

For example, the first configuration file may include the first setting information and the second setting information. Furthermore, the second configuration file may include the first setting information and the second setting information. However, the content of the first setting information stored in the first configuration file may be the same as or different from the content of the first setting information stored in the second configuration file. Similarly, the content of the second setting information stored in the first configuration file may be the same as or different from the content of the second setting information stored in the second configuration file.

For example, the first user 145 may decide the first configuration file to change or modify the content of the first setting information. The second user 155 may decide the second configuration file to change or modify the content of the first setting information. Also, the second user 155 may decide the third configuration file to change or modify the content of the first setting information. In detail, the second user 155 may decide the third configuration file through the communication device 130 (i.e., including an operation of accessing the second memory 120 through the communication device 130) of the robot control apparatus 100. In this case, the content of the first setting information expressed in the first configuration file may be different from the content of the first setting information expressed in the second configuration file. Here, to determine a target file for applying the content of the first setting information to the robot 160, the robot control apparatus 100 may select either the content of the first setting information included in the first configuration file or the content of the first setting information included in the second configuration file.

For example, the robot control apparatus 100 may include, in the target file, content of the first setting information determined by the first configuration file, content of the second setting information determined by the second configuration file, content of third setting information determined by the second configuration file, and content of fourth setting information determined by the first configuration file. In this case, when the robot control apparatus 100 applies the target file to the robot 160, the robot 160 may perform operations based on the content of the first setting information decided by the first user 145, the content of the second setting information decided by the second user 155, the content of the third setting information decided by the second user 155, and the content of the fourth setting information decided by the first user 145.

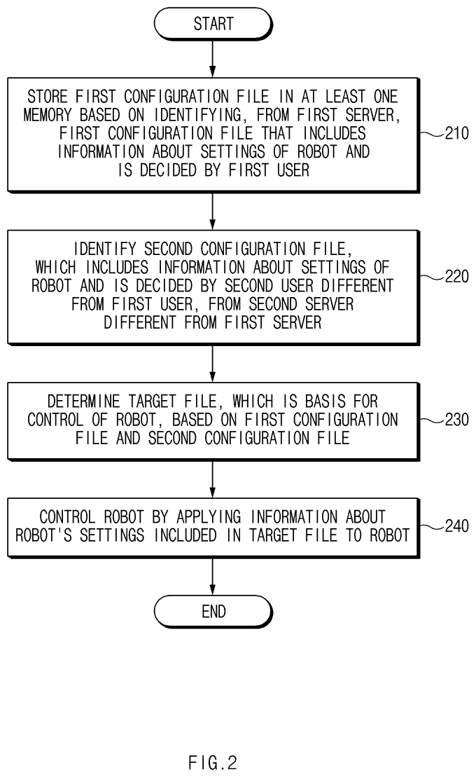

FIG. 2 shows an example of a method for controlling a robot, according to an example of the present disclosure. For convenience, FIG. 2 is described by way of an example in which the steps are performed by a processor (e.g., control circuitry). One, some, or all steps of the example method of FIG. 2, or portions thereof, may be performed by one or more other circuits. One or some, steps of the example method of FIG. 2 may be omitted, performed in other orders, and/or otherwise modified, and/or one or more additional steps may be added.

In operation 210, a robot control apparatus (e.g., the robot control apparatus 100 in FIG. 1) according to an example may store a first configuration file in at least one memory based on identifying, from a first server, the first configuration file that includes information about settings of a robot and is decided by a first user. For example, the robot control apparatus may receive the first configuration file from a first server through a communication device.

In operation 220, the robot control apparatus may identify a second configuration file, which includes information about the settings of the robot and is decided by a second user different from the first user, from a second server different from the first server. For example, when identifying the second configuration file from the second server, the robot control apparatus may store the second configuration file in at least one memory. Afterwards, the robot control apparatus may determine at least one of the first configuration file or the second configuration file as a target file, based on selection information included in the first configuration file.

The robot control apparatus may identify the first configuration file from the first server based on the fact that the first user decides information about the settings of the robot through the first server. The robot control apparatus may identify the second configuration file from the second server based on the fact that the second user decides information about the settings of the robot through the second server.

In operation 230, the robot control apparatus may determine the target file, which is the basis for control of the robot, based on the first configuration file and the second configuration file. For example, the robot control apparatus may identify first setting information and second setting information among information about the settings of the robot by identifying information about the settings of the robot from the first configuration file. The robot control apparatus may apply at least one of the first setting information included in the first configuration file or the first setting information included in the second configuration file to the target file based on the selection information of the first setting information. The robot control apparatus may apply at least one of the second setting information included in the first configuration file or the second setting information included in the second configuration file to the target file based on the selection information of the second setting information. The target file may include the first setting information (i.e., content included in at least one of the first configuration file or the second configuration file) and the second setting information (i.e., content included in at least one of the first configuration file or the second configuration file).

In operation 240, the robot control apparatus may control the robot by applying information about the robot's settings included in the target file to the robot. The robot control apparatus may identify at least one piece of setting information from the information about the robot's settings included in the target file. The robot control apparatus may control the robot by applying a setting name and setting-related content included in at least one piece of setting information to the robot.

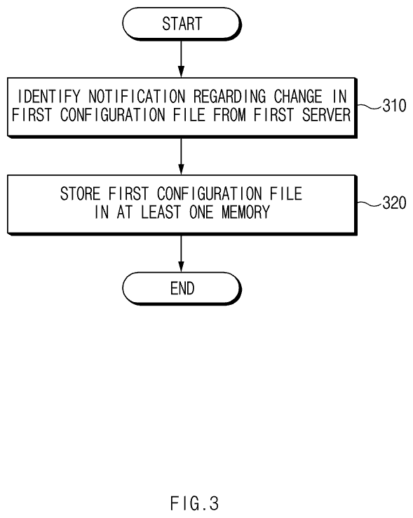

FIG. 3 shows an example of a method of storing a first configuration file in a robot control apparatus, according to an example of the present disclosure. For convenience, FIG. 3 is described by way of an example in which the steps are performed by a processor (e.g., control circuitry). One, some, or all steps of the example method of FIG. 3, or portions thereof, may be performed by one or more other circuits. One or some, steps of the example method of FIG. 3 may be omitted, performed in other orders, and/or otherwise modified, and/or one or more additional steps may be added.

In operation 310, a robot control apparatus (e.g., the robot control apparatus 100 in FIG. 1) according to an example may identify a notification regarding a change in a first configuration file from a first server. For example, if a new function is added or a function is changed by a first user, which is a robot software provider, the first server may change a setting name, setting content, and selection information of the setting. Afterwards, the first server may transmit a notification regarding the change in the first configuration file to the robot control apparatus. The robot control apparatus may identify the change in the first configuration file based on receiving the notification from the first server.

In operation 320, the robot control apparatus may store the first configuration file in at least one memory. For example, the robot control apparatus may store the changed first configuration file in the at least one memory based on identifying the notification regarding the change in the first configuration file from the first server. In detail, the first server may reflect the setting value, which is changed by the first user, to the first configuration file and may store the first configuration file to which the change is reflected. The robot control apparatus may receive the first configuration file, to which the change is reflected, from the first server. The robot control apparatus may store the first configuration file, to which change is reflected, in the at least one memory based on receiving the first configuration file to which the change is reflected.

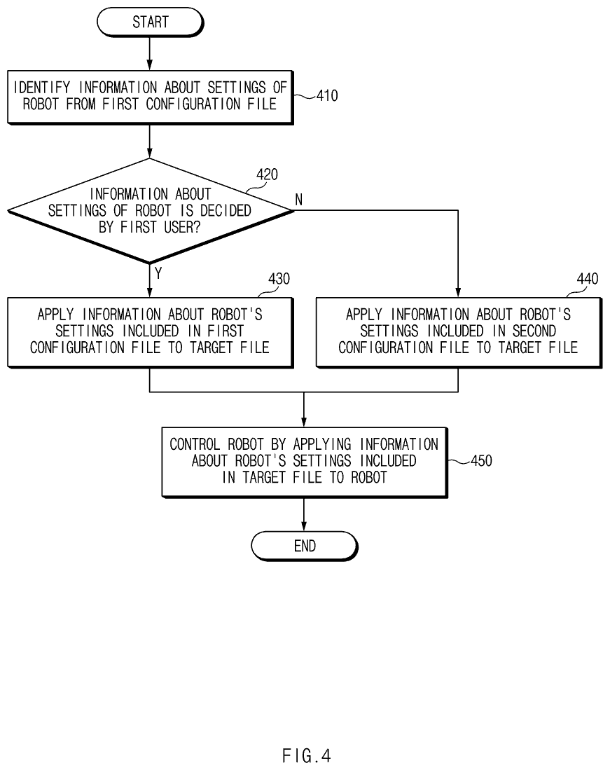

FIG. 4 shows an example of a method of controlling a robot through a target file based on a first configuration file and a second configuration file in a robot control apparatus, according to an example of the present disclosure. For convenience, FIG. 4 is described by way of an example in which the steps are performed by a processor (e.g., control circuitry). One, some, or all steps of the example method of FIG. 4, or portions thereof, may be performed by one or more other circuits. One or some, steps of the example method of FIG. 4 may be omitted, performed in other orders, and/or otherwise modified, and/or one or more additional steps may be added.

In operation 410, a robot control apparatus (e.g., the robot control apparatus 100 in FIG. 1) according to an example may identify information about settings of a robot from a first configuration file. For example, the robot control apparatus may identify first setting information and second setting information among information about the settings of the robot by identifying information about the settings of the robot from the first configuration file.

In operation 420, the robot control apparatus may determine whether information about the settings of the robot is decided by a first user. For example, the first setting information among pieces of information about robot settings will be described later. In this case, the robot control apparatus may determine whether the first setting information is decided by the first user, by identifying selection information of the first setting information.

If the first setting information is decided by the first user, in operation 430, the robot control apparatus may apply information about the robot's settings included in the first configuration file to the target file. For example, the robot control apparatus may apply the first setting information among the information about the robot settings included in the first configuration file to the target file.

If the first setting information is decided by a second user, not the first user, in operation 440, the robot control apparatus may apply information about the robot's settings included in the second configuration file to the target file. For example, the robot control apparatus may apply the first setting information among the information about the robot settings included in the second configuration file to the target file.

In operation 450, the robot control apparatus may control the robot by applying information about the robot's settings included in the target file to the robot. For example, the robot control apparatus may control the robot such that the robot performs the setting content included in the first setting information, by applying the first setting information among the information about the robot's settings included in the target file to the robot.

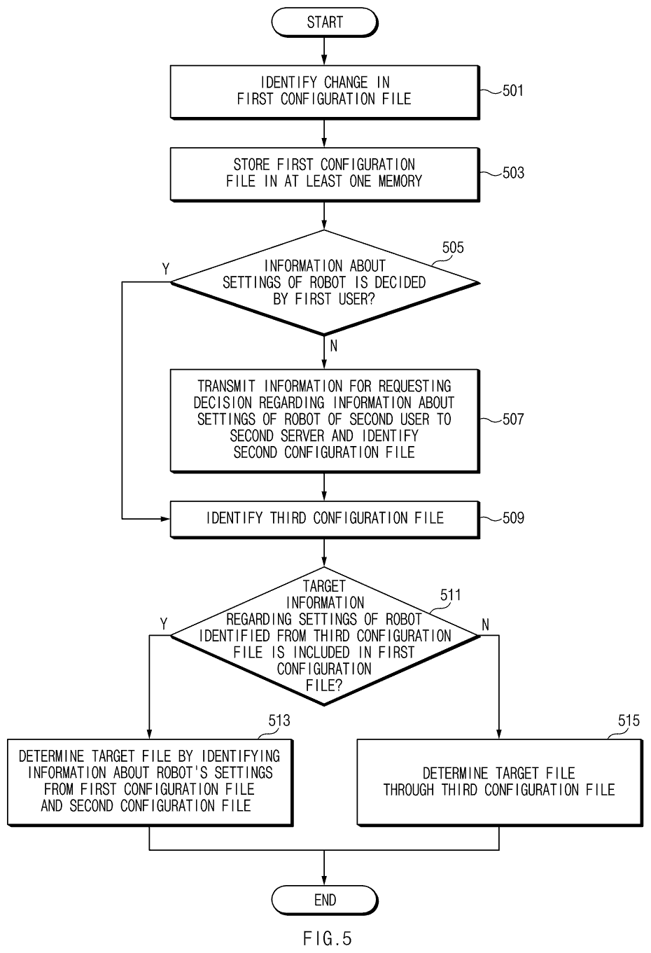

FIG. 5 shows an example of a method of controlling a robot through a target file based on first to third configuration files in a robot control apparatus, according to an example of the present disclosure. For convenience, FIG. 5 is described by way of an example in which the steps are performed by a processor (e.g., control circuitry). One, some, or all steps of the example method of FIG. 5, or portions thereof, may be performed by one or more other circuits. One or some, steps of the example method of FIG. 5 may be omitted, performed in other orders, and/or otherwise modified, and/or one or more additional steps may be added.

In operation 501, a robot control apparatus (e.g., the robot control apparatus 100 in FIG. 1) according to an example may identify a change in a first configuration file. For example, the robot control apparatus may identify a notification regarding a change in the first configuration file from a first server.

In operation 503, the robot control apparatus may store the first configuration file in at least one memory. However, an operation of the robot control apparatus is not limited thereto. For example, the robot control apparatus may store the first configuration file in the at least one memory without identifying a notification regarding a change in the first configuration file from the first server.

In operation 505, the robot control apparatus may determine whether information about the settings of the robot is decided by a first user. For example, the robot control apparatus may determine whether the first setting information among the information about the settings of the robot is decided by the first user.

If the first setting information is not decided by the first user, in operation 507, the robot control apparatus may identify the second configuration file by transmitting information for requesting a decision regarding information about the settings of the robot of the second user to a second server and receiving the second configuration file from the second server. For example, the second server may request an input from the second user based on receiving the above-described request information. Afterwards, to apply the first setting information to the target file, the robot control apparatus may compare the first configuration file with the second configuration file.

In detail, if the selection information of the first setting information is decided by the second user, the robot control apparatus may identify the first setting information from the second configuration file. The robot control apparatus may transmit information for requesting a decision regarding the first setting information of the second user to the second server based on the first setting information not being identified from the second configuration file. The robot control apparatus may apply the first setting information included in the second configuration file to the target file based on receiving the second configuration file decided by the second user from the second server.

For example, if the selection information of the first setting information is decided by the first user, the robot control apparatus may apply the first setting information included in the first configuration file to the target file. Similarly, if the selection information of the second setting information is decided by the second user, the robot control apparatus may apply the second setting information included in the second configuration file to the target file.

For example, if the selection information of the first setting information is decided by the second user, the robot control apparatus may apply the first setting information included in the second configuration file to the target file. Similarly, if the selection information of the second setting information is decided by the first user, the robot control apparatus may apply the second setting information included in the first configuration file to the target file.

For reference, the selection information of the first setting information may include information about permission where the first setting information is decided by at least one of the first user or the second user. The selection information of the second setting information may include information about permission where the second setting information is decided by at least one of the first user or the second user.

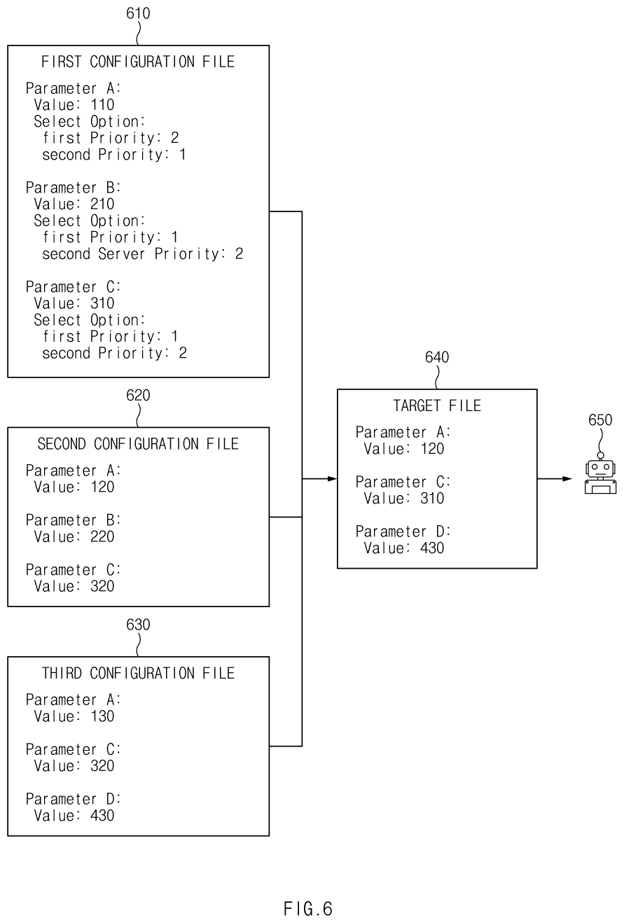

The robot control apparatus may apply at least one of the first setting information or the second setting information to the target file by comparing the priority of the first setting information and the priority of the second setting information, based on the fact that the selection information of the first setting information is the same as the selection information of the second setting information. A detailed description of a priority is provided below in FIG. 6.

In operation 509, the robot control apparatus may identify a third configuration file. For example, the robot control apparatus may identify the third configuration file pre-stored before the first configuration file is stored in at least one memory. The robot control apparatus may identify target information about the robot's settings from the third configuration file.

In operation 511, the robot control apparatus may determine whether target information regarding the settings of the robot identified from the third configuration file is included in the first configuration file. Here, the target information may indicate information, which is included in the third configuration file and which is to be used to control the robot. Moreover, the target information may include the same content as the first setting information and the second setting information.

In operation 513, the robot control apparatus may determine the target file by identifying information about the robot's settings from the first configuration file and the second configuration file based on the target information being included in the first configuration file. For example, the robot control apparatus may determine the target file by identifying information (e.g., the first setting information in the description of FIG. 5) about the robot's settings from the first configuration file based on the target information being included in the first configuration file.

In detail, the robot control apparatus may identify selection information (i.e., if target information is applied to a robot, information about a file, of which the content is to be applied, from among the first configuration file or the second configuration file) of target information included in the first configuration file. If the selection information of the target information is decided by the first user, the robot control apparatus may apply the target information included in the first configuration file to the target file. On the other hand, if the selection information of the target information is decided by the second user, the robot control apparatus may apply the target information included in the second configuration file to the target file.

In operation 515, the robot control apparatus may determine the target file through the third configuration file based on the target information not being included in the first configuration file. For example, the robot control apparatus may determine the target file through the third configuration file based on the target information not being included in the first configuration file. In other words, if target information is not included in the first configuration file, the robot control apparatus may omit the first configuration file and the second configuration file and may determine the third configuration file as the target file.

FIG. 6 shows an example of a first configuration file, a second configuration file, a third configuration file, and a target file in a robot control apparatus, according to an example of the present disclosure.

Referring to FIG. 6, a robot control apparatus (e.g., the robot control apparatus 100 in FIG. 1) according to an example may determine a target file 640 based on a first configuration file 610, a second configuration file 620, and a third configuration file 630. Afterwards, the robot control apparatus may control a robot 650 by applying information about settings of the robot included in the target file 640 to the robot 650.

In FIG. 6, for convenience of description, the information about the settings of the robot is described as including first setting information (e.g., parameter A), second setting information (e.g., parameter B), third setting information (e.g., parameter C), and fourth setting information (e.g., parameter D). Moreover, the information about settings of the robot may include setting information including a setting name (e.g., parameter X), content (e.g., a setting value) related to settings, and selection information (e.g., a select option) regarding permission of the settings. The setting name refers to the name of the attribute used for the robot's configuration and is held as a dataset. The selection information is used to determine whether to use setting values of a configuration file from a robot client, setting values from a configuration file of the robot, or setting values from a configuration file of a robot operation control.

Hereinafter, a description of operations for the robot control apparatus to determine the target file 640 will be described.

With regard to the first setting information, the robot control apparatus may identify the third configuration file 630 for determining the target file 640. The robot control apparatus may identify the first setting information, which is target information about the settings of the robot, from the third configuration file 630. The robot control apparatus may determine whether the first setting information is included in the first configuration file 610. The robot control apparatus may identify the first setting information included in the first configuration file 610 and then may identify selection information of the first setting information. Referring to FIG. 6, the selection information of the first setting information may include a second priority.

For example, the first priority may indicate the priority in which setting information (e.g., including first to third setting information) is determined (i.e., decided by a first user) by the first configuration file. On the other hand, the second priority may indicate the priority in which the setting information is determined by the second configuration file.

The selection information of the first setting information corresponds to the second priority, and thus the robot control apparatus may apply the first setting information included in the second configuration file 620 to the target file 640.

With regard to the second setting information, the robot control apparatus may identify the third configuration file 630 to determine the target file 640. The robot control apparatus may identify the second setting information, which is target information about the settings of the robot, from the third configuration file 630. When failing to identify the second setting information from the third configuration file 630, the robot control apparatus may not apply the second setting information to the target file 640.

With regard to the third setting information, the robot control apparatus may identify the third configuration file 630 for determining the target file 640. The robot control apparatus may identify the third setting information, which is target information about the settings of the robot, from the third configuration file 630. The robot control apparatus may determine whether the third setting information is included in the first configuration file 610. The robot control apparatus may identify the third setting information included in the first configuration file 610 and then may identify selection information of the third setting information. Referring to FIG. 6, the selection information of the third setting information may include a first priority. The selection information of the third setting information corresponds to the first priority, and thus the robot control apparatus may apply the third setting information included in the first configuration file 610 to the target file 640.

With regard to the fourth setting information, the robot control apparatus may identify the third configuration file 630 to determine the target file 640. The robot control apparatus may identify the fourth setting information, which is target information about the settings of the robot, from the third configuration file 630. The robot control apparatus may determine whether the fourth setting information is included in the first configuration file 610. The robot control apparatus may determine the target file 640 through the third configuration file 630 based on the fourth setting information, which is the target information, not being included in the first configuration file 610. In detail, the robot control apparatus may not identify the fourth setting information from the first configuration file 610, and thus the robot control apparatus may apply the fourth setting information included in the third configuration file 630 to the target file 640.

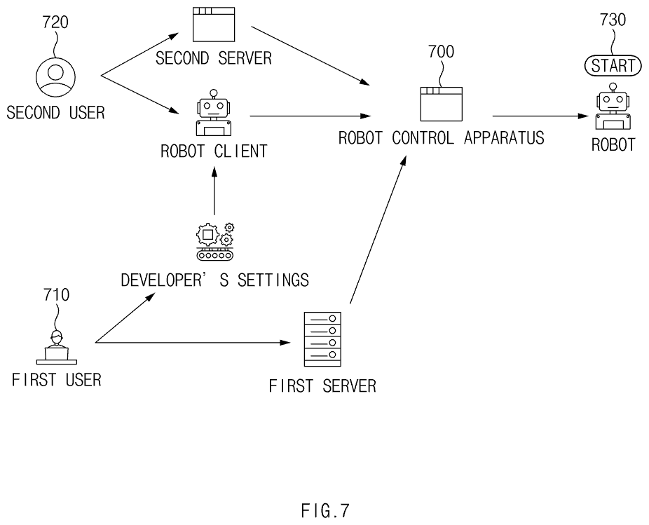

FIG. 7 shows an example of subjects that determine a configuration file related to control of a robot in a robot control apparatus, according to an example of the present disclosure.

A robot control apparatus 700 according to an example may communicate with a first server, a second server, a robot client, and a robot. For example, as described in FIGS. 1 to 6, the first server and the second server may communicate with a first user 710 and a second user 720, respectively. The robot client may indicate a server capable of distributing a configuration file based on the input of the second user 720.

The robot control apparatus 700 may control a robot 730 by receiving configuration files from the first server, second server, and the robot client, comparing received configuration files, and applying setting information about the robot included in the configuration files to the robot 730 through a target file.

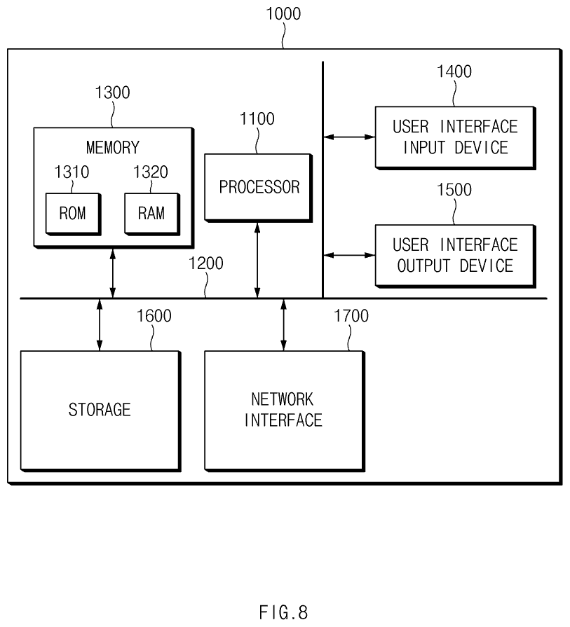

FIG. 8 shows an example of a computing system related to a robot control apparatus or a robot control method, according to an example of the present disclosure.

Referring to FIG. 8, a computing system 1000 related to a robot control apparatus or a robot control method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random-access memory (RAM).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random-access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The present disclosure was made to solve the above-mentioned problems occurring in the prior art while advantages achieved by the prior art are maintained intact.

An example of the present disclosure provides a robot control apparatus that may increase a user's convenience in operating a robot by providing a system capable of being changed in at least one of a method of setting a robot setting function provided by a provider in a robot client, a method of setting the robot setting function in a robot operation control, or, a method using values set by a robot software provider, such that the user is capable of setting the robot by determining a target file that is the basis for robot control based on a first configuration file and a second configuration file, and a control method thereof.

Moreover, an example of the present disclosure provides a robot control apparatus that may reduce man-hours for developing software and reduce distribution costs by changing the robot setting method without updating robot control software in adding new functions and changing existing functions, by determining the target file that is the basis for robot control through comparison of priorities of pieces of setting information identified from a configuration file, and a control method thereof.

Furthermore, an example of the present disclosure provides a robot control apparatus that may increase robot management convenience from a supplier's perspective as functions capable of being set by the robot client or the operation control may be disabled for testing during initial development by identifying selection information of setting information among pieces of information about robot settings, and a control method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a robot control apparatus may include at least one memory that stores computer-executable instructions, a communication device that supports communication with at least one server, and at least one processor that executes the instructions by accessing the memory. The at least one processor may store a first configuration file in the at least one memory based on identifying the first configuration file, which includes information about a setting of a robot and is decided by a first user, from a first server, may identify a second configuration file, which includes the information about the setting of the robot and is decided by a second user different from the first user, from a second server different from the first server, may determine a target file, which is a basis for control of the robot, based on the first configuration file and the second configuration file, and may control the robot by applying the information about the setting of the robot included in the target file to the robot.

In an example, the at least one processor may identify first setting information and second setting information among the information about the setting of the robot by identifying the information about the setting of the robot from the first configuration file, and may identify selection information of the first setting information and selection information of the second setting information. The information about the setting of the robot may include setting information including a setting name, content about a setting, and selection information about permission of the setting.

In an example, the at least one processor may apply the first setting information included in the first configuration file to the target file if the selection information of the first setting information is decided by the first user, and may apply the second setting information included in the second configuration file to the target file if the selection information of the second setting information is decided by the second user.

In an example, the at least one processor may apply the first setting information included in the second configuration file to the target file if the selection information of the first setting information is decided by the second user, and may apply the second setting information included in the first configuration file to the target file if the selection information of the second setting information is decided by the first user.

In an example, the at least one processor may apply at least one of the first setting information or the second setting information to the target file by comparing a priority of the first setting information with a priority of the second setting information, based on the selection information of the first setting information being the same as the selection information of the second setting information. The selection information of the first setting information may include information about permission, where the first setting information is decided by at least one of the first user or the second user. The selection information of the second setting information may include information about permission, where the second setting information is decided by at least one of the first user or the second user.

In an example, the at least one processor may identify the second setting information from the second configuration file if the selection information of the second setting information is decided by the second user, may transmit information for requesting a decision about the second setting information of the second user to the second server based on the second setting information not being identified from the second configuration file, and may apply the second setting information included in the second configuration file to the target file based on receiving the second configuration file decided by the second user from the second server.

In an example, the at least one processor may identify the first configuration file from the first server based on the first user deciding the information about the setting of the robot through the first server, and may identify the second configuration file from the second server based on the second user deciding the information about the setting of the robot through the second server.

In an example, the at least one processor may store the first configuration file, which is changed, in the at least one memory based on identifying a notification regarding a change in the first configuration file from the first server.

In an example, the at least one processor may identify a third configuration file pre-stored before the first configuration file is stored in the at least one memory, may identify target information about the setting of the robot from the third configuration file, and may determine whether the target information is included in the first configuration file.

In an example, the at least one processor may determine the target file by identifying the information about the setting of the robot from the first configuration file based on the target information being included in the first configuration file, and may determine the target file through the third configuration file based on the target information not being included in the first configuration file.

According to an example of the present disclosure, a robot control method may include storing a first configuration file in at least one memory based on identifying the first configuration file, which includes information about a setting of a robot and is decided by a first user, from a first server, identifying a second configuration file, which includes the information about the setting of the robot and is decided by a second user different from the first user, from a second server different from the first server, determining a target file, which is a basis for control of the robot, based on the first configuration file and the second configuration file, and controlling the robot by applying the information about the setting of the robot included in the target file to the robot.

In an example, the controlling of the robot may include identifying first setting information and second setting information among the information about the setting of the robot by identifying the information about the setting of the robot from the first configuration file, and identifying selection information of the first setting information and selection information of the second setting information. The information about the setting of the robot may include setting information including a setting name, content about a setting, and selection information about permission of the setting.

In an example, the controlling of the robot may include applying the first setting information included in the first configuration file to the target file if the selection information of the first setting information is decided by the first user, and applying the second setting information included in the second configuration file to the target file if the selection information of the second setting information is decided by the second user.

In an example, the controlling of the robot may include applying the first setting information included in the second configuration file to the target file if the selection information of the first setting information is decided by the second user, and applying the second setting information included in the first configuration file to the target file if the selection information of the second setting information is decided by the first user.

In an example, the controlling of the robot may include applying at least one of the first setting information or the second setting information to the target file by comparing a priority of the first setting information with a priority of the second setting information, based on the selection information of the first setting information being the same as the selection information of the second setting information. The selection information of the first setting information may include information about permission, where the first setting information is decided by at least one of the first user or the second user. The selection information of the second setting information may include information about permission, where the second setting information is decided by at least one of the first user or the second user.

In an example, the controlling of the robot may include identifying the second setting information from the second configuration file if the selection information of the second setting information is decided by the second user, transmitting information for requesting a decision about the second setting information of the second user to the second server based on the second setting information not being identified from the second configuration file, and applying the second setting information included in the second configuration file to the target file based on receiving the second configuration file decided by the second user from the second server.

In an example, the controlling of the robot may include identifying the first configuration file from the first server based on the first user deciding the information about the setting of the robot through the first server, and identifying the second configuration file from the second server based on the second user deciding the information about the setting of the robot through the second server.

In an example, the controlling of the robot may include storing the first configuration file, which is changed, in the at least one memory based on identifying a notification regarding a change in the first configuration file from the first server.

In an example, the controlling of the robot may include identifying a third configuration file pre-stored before the first configuration file is stored in the at least one memory, identifying target information about the setting of the robot from the third configuration file, and determining whether the target information is included in the first configuration file.

In an example, the controlling of the robot may include determining the target file by identifying the information about the setting of the robot from the first configuration file based on the target information being included in the first configuration file, and determining the target file through the third configuration file based on the target information not being included in the first configuration file.

The above description is merely an example of the technical idea of the present disclosure, and various modifications and modifications may be made by one skilled in the art without departing from the essential characteristic of the present disclosure.

The above-described examples may be implemented with hardware elements, software elements, and/or a combination of hardware elements and software elements. For example, the devices, methods, and components described in examples of the present disclosure may be implemented by using general-use computers or special-purpose computers, such as a processor, a controller, an arithmetic logic unit (ALU), a digital signal processor, a microcomputer, a field programmable array (FPA), a programmable logic unit (PLU), a microprocessor, or any device which may execute instructions and respond. A processing device may perform an operating system (OS) or a software application running on the OS. Further, the processing device may access, store, manipulate, process and generate data in response to execution of software. It will be understood by those skilled in the art that although a single processing device may be shown for convenience of understanding, the processing device may include a plurality of processing elements and/or a plurality of types of processing elements. For example, the processing device may include a plurality of processors or one processor and one controller. Also, the processing device may include a different processing configuration, such as a parallel processor.

Software may include computer programs, codes, instructions or one or more combinations thereof and configure a processing device to operate in a desired manner or independently or collectively control the processing device. Software and/or data may be permanently or temporarily embodied in any type of machine, components, physical equipment, virtual equipment, computer storage media or units or transmitted signal waves so as to be interpreted by the processing device or to provide instructions or data to the processing device. Software may be dispersed throughout computer systems connected over networks and be stored or executed in a dispersion manner. Software and data may be recorded in a computer-readable storage medium.

The methods according to the above-described examples may be recorded in a computer-readable medium including program instructions that are executable through various computer devices. The computer-readable medium may also include program instructions, data files, data structures, and the like, singly or in combination. The program instructions recorded in the medium may be designed and configured specially for the examples of the present disclosure or may be known and available to those skilled in computer software. The computer-readable medium may include hardware devices, which are specially configured to store and execute program instructions, such as magnetic media (e.g., a hard disk, a floppy disk, or a magnetic tape), optical recording media (e.g., CD-ROM and DVD), magneto-optical media (e.g., a floptical disk), read only memories (ROMs), random access memories (RAMs), and flash memories. Examples of computer programs include not only machine language codes created by a compiler, but also high-level language codes that are capable of being executed by a computer by using an interpreter or the like.

The hardware device described above may be configured to act as one or more software modules to perform the operations of the above-described examples of the present disclosure, or vice versa.

Even though the examples are described with reference to restricted drawings, it may be obviously to one skilled in the art that the examples are variously changed or modified based on the above description. For example, adequate effects may be achieved even when the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other examples, and equivalents to claims are within the scope of the following claims.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

Descriptions of a robot control apparatus according to an example of the present disclosure, and a control method thereof are as follows.

According to at least one of examples of the present disclosure, it is possible to increase a user's convenience in operating a robot by providing a system capable of being changed in at least one of a method of setting a robot setting function provided by a provider in a robot client, a method of setting the robot setting function in a robot operation control, or, a method using values set by a robot software provider, such that the user is capable of setting the robot by determining a target file that is the basis for robot control based on a first configuration file and a second configuration file.

Moreover, according to at least one of examples of the present disclosure, it is possible to reduce man-hours for developing software and to reduce distribution costs by changing the robot setting method without updating robot control software in adding new functions and changing existing functions, by determining the target file that is the basis for robot control through comparison of priorities of pieces of setting information identified from a configuration file. Furthermore, according to at least one of examples of the present disclosure, it is

possible to increase robot management convenience from a supplier's perspective as functions capable of being set by the robot client or the operation control may be disabled for testing during initial development by identifying selection information of setting information among pieces of information about robot settings.

Besides, a variety of effects directly or indirectly understood through the present disclosure may be provided.

Hereinabove, although the present disclosure was described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a robot, the apparatus comprising:
at least one memory storing at least one instruction;
a communication device configured to support communication with at least one server; and
at least one processor operatively coupled to the at least one memory,
wherein the at least one instruction, when executed by the at least one processor, is configured to cause the apparatus to:
store, based on determining that a first configuration file is received via the communication device from a first server, the first configuration file, wherein the first configuration file comprises first information about a first user's setting of the robot;
determine a second configuration file received via the communication device from a second server different from the first server, wherein the second configuration file comprises second information about a second user's setting of the robot, and wherein the second user is different from the first user;
determine, based on the first configuration file and the second configuration file, a target file, wherein the target file comprises target information about a target setting associated with control of the robot; and
control, based on the target information, the robot.

2. The apparatus of claim 1, wherein the at least one instruction, when executed by the least one processor, is configured to cause the apparatus to:
determine, based on the first configuration file or the second configuration file, first setting information and second setting information, wherein each of the first setting information and the second setting information comprises at least one of a parameter name associated with a setting or a value related to the setting; and
determine first selection information of the first setting information and second selection information of the second setting information, wherein each of the first selection information and the second selection information comprises information about permission of the setting.

3. The apparatus of claim 2, wherein the at least one instruction, when executed by the at least one processor, is configured to cause the apparatus to:
apply, based on the first selection information being decided by the first user, the first setting information to the target file, wherein the first setting information is included in the first configuration file; and
apply, based on the second selection information being decided by the second user, the second setting information to the target file, wherein the second setting information is included in the second configuration file.

4. The apparatus of claim 2, wherein the at least one instruction, when executed by the at least one processor, is configured to cause the apparatus to:
apply, based on the first selection information being decided by the second user, the first setting information to the target file, wherein the first setting information is included in the second configuration file; and
apply, based on the second selection information being decided by the first user, the second setting information to the target file wherein the second setting information is included in the first configuration file.

5. The apparatus of claim 2, wherein the at least one instruction, when executed by the at least one processor, is configured to cause the apparatus to:
based on the first selection information of the first setting information being the same as the second selection information of the second setting information, apply at least one of the first setting information or the second setting information to the target file by comparing a first priority of the first setting information with a second priority of the second setting information,
wherein the first selection information of the first setting information comprises information about permission, wherein the first setting information is decided by at least one of the first user or the second user, and
wherein the second selection information of the second setting information comprises information about permission, where the second setting information is decided by at least one of the first user or the second user.

6. The apparatus of claim 3, wherein the at least one instruction, when executed by the at least one processor, is configured to cause the apparatus to:
determine, based on the second selection information being decided by the second user, the second setting information from the second configuration file;
based on the second setting information not being determined from the second configuration file, transmit, to the second server, information for requesting a decision of the second user about the second setting information; and
apply, based on receiving the second configuration file decided by the second user from the second server, the second setting information to the target file, wherein the second setting information is included in the second configuration file.

7. The apparatus of claim 1, wherein the at least one instruction, when executed by the at least one processor, is configured to cause the apparatus to:
determine, based on the first user deciding the first information about the first user's setting of the robot through the first server, the first configuration file from the first server, wherein the first user is a robot software provider; and
determine, based on the second user deciding the second information about the second user's setting of the robot through the second server, the second configuration file from the second server, wherein the second server is configured to provide a robot operation control.

8. The apparatus of claim 1, wherein the at least one instruction, when executed by the at least one processor, is configured to cause the apparatus to:
store, based on identifying a notification regarding a change in the first configuration file from the first server, the first configuration file, which is changed, in the at least one memory.

9. The apparatus of claim 1, wherein the at least one instruction, when executed by the at least one processor, is configured to cause the apparatus to:
determine a third configuration file pre-stored before the first configuration file is stored in the at least one memory;
determine the target information about the target setting of the robot from the third configuration file; and
determine whether the target information is included in the first configuration file.

10. The apparatus of claim 9, wherein the at least one instruction, when executed by the at least one processor, is configured to cause the apparatus to:
determine, based on the target information being included in the first configuration file, the target file by determining the first information about the first user's setting of the robot from the first configuration file; and
determine, based on the target information not being included in the first configuration file, the target file through the third configuration file.

11. A method performed by an apparatus for controlling a robot, the method comprising:
storing, based on determining that a first configuration file is received from a first server, the first configuration file in at least one memory, wherein the first configuration file comprises first information about a first user's setting of a robot;
determining a second configuration file received from a second server different from the first server, wherein the second configuration file comprises second information about a second user's setting of the robot, and wherein the second user is different from the first user,
determining, based on the first configuration file and the second configuration file, a target file, wherein the target file comprises target information about a target setting associated with control of the robot; and
controlling, based on the target information, the robot.

12. The method of claim 11, wherein the controlling the robot comprises:
determining, based on the first configuration file or the second configuration file, first setting information and second setting information, wherein each of the first setting information and the second setting information comprises at least one of a parameter name associated with a setting or a value related to the setting; and
determining first selection information of the first setting information and second selection information of the second setting information, wherein each of the first selection information and the second selection information comprises information about permission of the setting.

13. The method of claim 12, wherein the controlling the robot comprises:
applying, based on the first selection information being decided by the first user, the first setting information to the target file, wherein the first setting information is included in the first configuration file; and
applying, based on the second selection information being decided by the second user, the second setting information to the target file, wherein the second setting information is included in the second configuration file.

14. The method of claim 12, wherein the controlling the robot comprises:
applying, based on the first selection information being decided by the second user, the first setting information to the target file, wherein the first setting information is included in the second configuration file; and
applying, based on the second selection information being decided by the first user, the second setting information to the target file wherein the second setting information is included in the first configuration file.

15. The method of claim 12, wherein the controlling the robot comprises:
based on the first selection information of the first setting information being the same as the second selection information of the second setting information, applying at least one of the first setting information or the second setting information to the target file by comparing a first priority of the first setting information with a second priority of the second setting information,
wherein the first selection information of the first setting information comprises information about permission, wherein the first setting information is decided by at least one of the first user or the second user, and
wherein the second selection information of the second setting information comprises information about permission, where the second setting information is decided by at least one of the first user or the second user.

16. The method of claim 13, wherein the controlling the robot comprises:
determining, based on the second selection information being decided by the second user, the second setting information from the second configuration file;
based on the second setting information not being determined from the second configuration file, transmitting, to the second server, information for requesting a decision of the second user about the second setting information; and
applying, based on receiving the second configuration file decided by the second user from the second server, the second setting information to the target file, wherein the second setting information is included in the second configuration file.

17. The method of claim 11, wherein the controlling the robot comprises:
determining, based on the first user deciding the first information about the first user's setting of the robot through the first server, the first configuration file from the first server, wherein the first user is a robot software provider; and
determining, based on the second user deciding the second information about the second user's setting of the robot through the second server, the second configuration file from the second server, wherein the second server is configured to provide a robot operation control.

18. The method of claim 11, wherein the controlling the robot comprises:
storing, based on identifying a notification regarding a change in the first configuration file from the first server, the first configuration file, which is changed, in the at least one memory.

19. The method of claim 11, wherein the controlling the robot comprises:
determining a third configuration file pre-stored before the first configuration file is stored in the at least one memory;
determining the target information about the target setting of the robot from the third configuration file; and
determining whether the target information is included in the first configuration file.

20. The method of claim 19, wherein the controlling the robot comprises:
determining, based on the target information being included in the first configuration file, the target file by determining the first information about the first user's setting of the robot from the first configuration file; and
determining, based on the target information not being included in the first configuration file, the target file through the third configuration file.
